(19) United States
(12) Patent Application Publication
(10) Pub. No.: US 2017/0193397 A1
(43) Pub. Date: Jul. 6, 2017

(54) REAL TIME ORGANIZATION PULSE GATHERING AND ANALYSIS USING MACHINE LEARNING AND ARTIFICIAL INTELLIGENCE

(71) Applicant: Accenture Global Solutions Limited, Dublin (IE)

(72) Inventors: Samatha Kottha, Bangalore (IN); Bhavana Rao, Bangalore (IN); Suraj Gjadhav, Mumbai (IN); Jayati Deshmukh, Bangalore (IN); Annervaz Karukapadath Mohamedrasheed, Trichur (IN); Sanjay Podder, Thane (IN); Shubhashis Sengupta, Bangalore (IN)

(21) Appl. No.: 15/185,869

(22) Filed: Jun. 17, 2016

(30) Foreign Application Priority Data
Dec. 30, 2015 (IN) 7057CHE2015

(51) Int. Cl. G06N 99/00; G06F 17/28; G06F 17/27; G06F 17/30

(52) U.S. Cl. CPC G06N 99/005; G06F 17/30713; G06F 17/2836; G06F 17/2705

(57) ABSTRACT

Methods, systems, and apparatus, including computer programs encoded on a computer storage medium, for natural language processing of unstructured text are disclosed. In one aspect, a method includes the actions of receiving one or more unstructured data entries that each include one or more sentences, are each associated with an entity, and are each from a user. The actions further include parsing the one or more sentences. The actions further include determining one or more classifications of each unstructured data entry. The actions further include determining a sentiment. The actions further include accessing structured data. The actions further include defining one or more groups of users based on the structured data, wherein each of the one or more groups shares a common characteristic in the structured data. The actions further include determining sentiments to associate with the group.

### CROSS REFERENCE TO RELATED APPLICATION

This application claims the benefit of Indian Patent Application No. 7057/CHE/2015, filed Dec. 30, 2015, the contents of which are incorporated by reference.

### TECHNICAL FIELD

This application generally relates to natural language processing and machine learning.

### BACKGROUND

Natural language processing and machine learning techniques may be used by a computer to process natural language text and extract information from the natural language text.

### SUMMARY

Entities may use natural language processing to identify topics or aspects or both of unstructured, natural language text. The natural language processing may involve identifying topics/aspects associated with the unstructured data and any sentiments expressed towards those topics/aspects as well as overall sentiment. The natural language processing may involve machine learning techniques. The natural language processor may receive data from a machine learning system that was trained using labeled training data that includes identified topics/aspects and corresponding sentiments. The training data may include various text snippets. Additionally, each entity may have complied structured data that may be used to group the sources of the labeled data. Based on the groups of the sources of the labeled data, the sentiments, and the topics/aspects, the system may identify sentiments and topics/aspects that may be common to particular groups. The system then generates a user interface to present the groups and their associated topics/aspects and sentiments.

An innovative aspect of the subject matter described in this specification may be implemented in a method that includes the actions of receiving one or more unstructured data entries that each include one or more sentences, are each associated with an entity, and are each from a user; for each unstructured data entry, determining whether to translate the one or more sentences in the unstructured data entry to a common language; for each unstructured data entry, parsing the one or more sentences; based on the parsed one or more sentences, determining one or more classifications of each unstructured data entry; for each of the one or more classifications, determining a sentiment; accessing structured data that is associated with each entity; defining one or more groups of users based on the structured data, where each of the one or more groups shares a common characteristic in the structured data; for each of the one or more groups of users, determining sentiments to associate with the group based on the sentiments associated with the one or more unstructured data entries and based on the entity associated with the respective unstructured data entries; generating a user interface that includes interface elements for each of the one or more groups and the associated sentiments and classifications; and providing, for output, the user interface.

These and other implementations can each optionally include one or more of the following features. The action of determining a sentiment includes determining the sentiment using one or more of a recursive neural tensor network, a linear support vector machine, a convolutional neural network (CNN), a dynamic memory network (DMN), or a rule based algorithm. The actions further include receiving additional structured data that is associated with an additional user; based on the additional structured data, identifying, from the one or more groups, a particular group to associate with the additional user; and determining that the additional user will be associated with the sentiment that is associated with the particular group. The structured data includes demographic data, employment data, and location data. Each of the one or more unstructured data entry includes a time stamp. The action of determining sentiments to associate with the group includes determining sentiment trends to associate with the group. The actions further include identifying one or more events that are associated with a respective entity of the structured data; and determining a relationship between the sentiment trends and the one or more events. The actions further include receiving, from an owner of the structured data or from a respective entity, data identifying the one or more classifications. The actions further include, for each of the one or more classifications, determining a sentiment intensity score, where determining sentiments to associate with the group comprises determining a sentiment intensity score to associate with the group based on the sentiment intensity scores.

Other implementations of this aspect include corresponding systems, apparatus, and computer programs recorded on computer storage devices, each configured to perform the operations of the methods.

Particular implementations of the subject matter described in this specification can be implemented so as to realize one or more of the following advantages. A system may identify sentiments of various groups of employees and apply corrective action to improve negative sentiments.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1 and 2 illustrate example systems that perform natural language processing of unstructured text.

FIG. 3 illustrates an example user interface for a system that performs natural language processing of unstructured text.

FIG. 4 illustrates an example user interface for structured and unstructured data processing.

FIG. 5 illustrates an example process for performing natural language processing of unstructured text.

FIG. 6 illustrates an example of a computing device and a mobile computing device.

Like reference numbers and designations in the various drawings indicate like elements.

### DETAILED DESCRIPTION

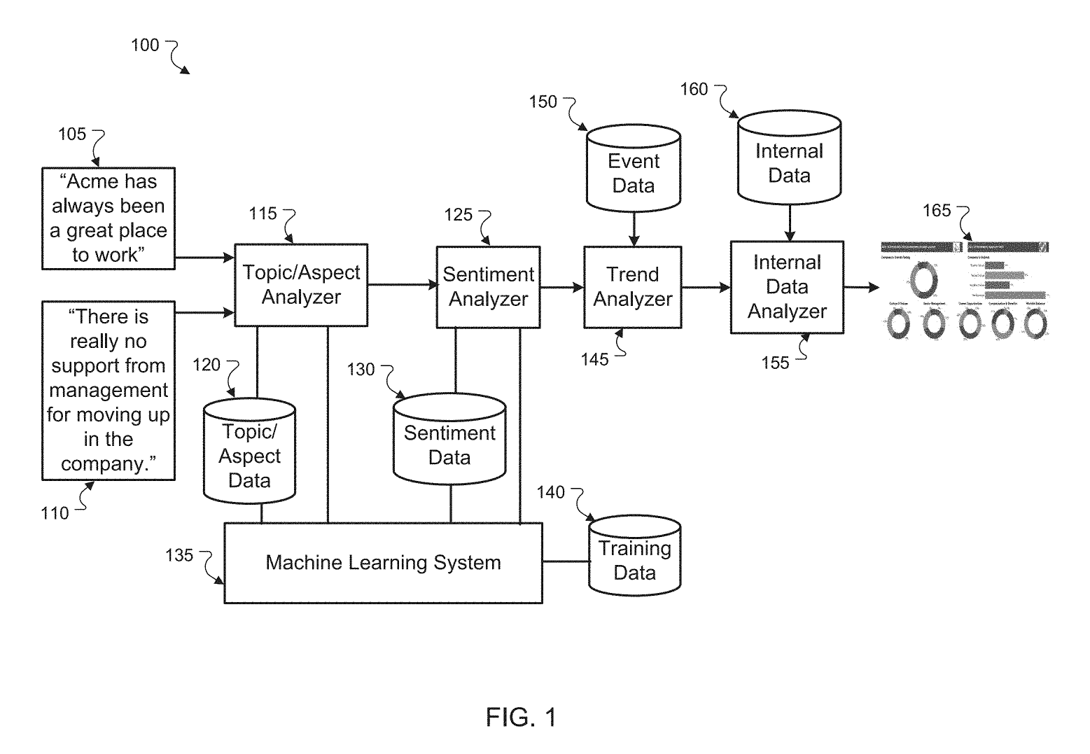

FIG. 1 illustrates an example system 100 that performs natural language processing of unstructured text. Briefly, and as described in further detail below, the system 100 receives review data that is from employees who are providing feedback to their employers related to their work environment. The system 100 processes the review data and identifies different topics or aspects or both (topics/aspects) for each review and sentiments that corresponds to each of the different topics/aspects. The system 100 then correlates the sentiments and topics/aspects to the employer's data to identify groups of employees whose reviews are related to similar topics/aspects and sentiments.

In the example shown in FIG. 1, the system 100 receives review data 105 and 110. The review data 105 and 110 may be received from employees that work for an employer and may relate to feedback that the employees have related to their job. In FIG. 1, the example review data 105 indicates that “Acme has always been a great place to work.” The example review data 110 indicates that “There is really no support from management for moving up in the company.” The review data 105 and 110 may each be associated with a particular employee with the system relating each of the review data 105 and 110 with an employee identifier and may not be easily parsable. In some implementations, the system may remove any employee identifying information, thus anonymizing or abstracting the review data 105 and 110.

The system 100 provides the review data to the topic/aspect analyzer 115. The topic/aspect analyzer 115 analyzes the review data 105 and 110 and identifies a language that each review was written in. The topic/aspect analyzer 115 parses the review data 105 and 110 into different portions using natural language processing. The topic/aspect analyzer 115 may parse the sentences of the review data 105 and 110 to identify subjects, verbs, objects, and other parts of a sentence. In the event that the review data 105 and 110 does not include complete sentences, the topic/aspect analyzer 115 may identify a likely part of speech for each word or groups of words. Once the topic/aspect analyzer 115 has parsed the review data 105 and 110, the topic/aspect analyzer identifies likely topics/aspects that are associated with the review data 105. The topic/aspect analyzer 115 may compare topic/aspect data 120 with the terms from the parsed review. The topic/aspect data 120 may include terms for the topic/aspect analyzer 115 to identify where one or more terms may relate to a particular topic/aspect. For example, the topic/aspect data 120 may include terms such as “great company” that is associated with a “pride” topic/aspect. The topic/aspect data 120 may include terms such as “company to work with” being associated with a “work activities” topic, “moving up in the company” being associated with a “career opportunities” topic, and “support from management” being associated with a “coaching guidance” topic/aspect.

In some implementations, the topic/aspect analyzer 115 may be preceded by a translator. The translator translates the review data 105 and 110 into a common language. For example, the translator translates the review data 105 and 110 into English using machine translation. The translator may analyze the review data 105 and 110 and determine that they are already in the same language and that no translation is necessary. In some implementations, the translator may analyze the review data and identify a most common language among the reviews. The translator may translate the reviews that are in other languages to the common language. For example, review data 105 and 110 may be in Spanish and one other review may be in English. Because Spanish is the most common language in the group of reviews, the translator translates the English review to Spanish.

In some implementations, the topic/aspect data 120 may include taxonomy data received from an entity that wants to identify certain topics/aspects from the review data. The taxonomy data may include different levels of topics/aspects and associated keywords to identify in the review data. For example, the taxonomy data may include an “engagement” topic/aspect. At a level below the “engagement” topic, the subcategory may include “pride,” “say,” “stay,” and “strive.” For each subcategory, the taxonomy data may include keywords. For example, for the “pride” subcategory, the keywords may include “love,” “like,” “admire,” “proud,” “luv,” “pleasure,” “enjoy,” “honored,” “pride,” “enjoy being here,” “satisfied,” “GPTW,” “lucky,” “glad,” and “TOP OF THE WORLD.” When the topic/aspect analyzer 120 identifies a keyword in the taxonomy data, the topic/aspect analyzer then assigns the corresponding topic/aspect to the portion of the review data. In some implementations, the keywords may include keywords to exclude. For example, for the “pride” subcategory, the keywords may exclude “associate,” “resume,” “video,” “software,” and “hardware.”

In some implementations, the topic/aspect analyzer 115 uses a linear support vector machine to identify topics/aspects. The linear support vector machine builds a model using training data that specifies sample inputs and their classification. Using this model, any new input can be classified into one of the classes. As an example, the linear support vector machine may be trained using about ten thousand sentences.

The topic/aspect analyzer 115 provides the parsed review data along with the identified topics/aspects to the sentiment analyzer 125. The sentiment analyzer 125 identifies a sentiment that is associated with each topic/aspect. In some implementations, the sentiment analyzer 125 identifies a sentiment that is associated with each review or sentence. The sentiment may be negative, neutral, or positive. In some implementations, the sentiment includes a sentiment intensity score that is on a scale of −1 to 1 with −1 being negative, 0 being neutral, and 1 being positive. To identify a sentiment, the sentiment analyzer 125 may use a recursive neural tensor network, a convolutional neural network, or a dynamic memory network that uses deep learning to find the sentiment. The deep learning algorithms convert each word into a vector of real numbers and represent the text snippet as the concatenation of these vectors. These word vectors are pre trained using word2vec or GloVe models on a general corpus, e.g., common crawl. The words which are domain specific alone were retrained on the domain specific corpus. The recursive neural tensor network builds a parse tree of the input sentence (which is represented now as a sequence of real numbers), examines how the input sentence interacts base on the parse tree, and determines the overall sentiment of the sentence. A convolutional neural network applies a convolution operator on the sentences again to predict the sentiment from the sequence of real numbers. Dynamic Memory networks uses Long Short Term Memory and other advanced deep learning techniques to predict the sentiment from the sequence of real numbers. Alternatively, or in addition, the sentiment analyzer 125 may use a rule based algorithm. The rule based algorithm builds a parse tree of the input sentence and then finds the sentiment of each word and merges the word at a clause level and a sentence level based on grammatical dependencies and predefined rules. In some implementations, the sentiment analyzer 125 determines a sentiment intensity score based on a score assigned to each word or based on a classifier confidence. Some words may increase a sentiment intensity score and others may decrease the sentiment intensity score. Some words may increase or decrease the intensity score depending on the part of speech or on context. For example, “work” may have different effects on the intensity score depending if it is used as a noun or a verb. In some implementations, the intensity score can be assigned by appropriate scaling of the underlying classifiers confidence in predicting the overall sentiment.

The system includes a machine learning system 135 that is configured to provide data to the topic/aspect analyzer 115 for identifying topics/aspects and to the sentiment analyzer for identifying sentiments. The system 100 may train the machine learning system 135 using the training data 140. The training data 140 may include various entries of review data and assigned topics/aspects and sentiments. The machine learning system 135 may provide words or terms to the topic/aspect data 120 as well as rules and algorithms to the topic/aspect analyzer 115 to identify the words or terms in the topic/aspect data 120. Similarly, the machine learning system 135 may provide words or terms to the sentiment data 130 as well as rules and algorithms to the sentiment analyzer 125 to assign the sentiments. The machine learning system 135 may be continuously or periodically updated with updated training data. For example, an employer that is receiving reviews from employees may supply training data from a prior year. The training data may have been reviewed by other employees or a third party to ensure accuracy of the selected sentiments and topics/aspects.

The sentiment analyzer 125 provides the review data 105 and 110 along with the identified topics/aspects and sentiments to the trend analyzer 145. The trend analyzer 145 analyzes the reviews, topics, and sentiments to identify patterns. In some implementations, the each of the reviews includes a timestamp. The trend analyzer 145 may use the timestamp to identify changes in sentiments for particular topics/aspects over a period of time. For example, the trend analyzer 145 may determine that the sentiment for the topic/aspect “work life balance” has improved over the past year. In some implementations, the trend analyzer 145 may receive specific topics/aspects for which to identify patterns. For example, an employer may provide the trend analyzer 145 instructions to identify any trends in the topic/aspect “safety” in the previous six months.

In some implementations, the trend analyzer 145 may correlate identified patterns or trends to particular events. The trend analyzer 145 may access the event data 150. The event data 150 includes data for events that occurred that are related to the company. For example, the events may include the date that the company merged with another company, or the date that a new chief executive officer started working. The trend analyzer 145 may map an improvement in the sentiment of the “pride” category occurred after a new chief executive officer started. The event data 150 may also include events that may not be considered related to the company. For example, the event data 150 may include news events, weather events, political events, sporting events, or any other similar type of event. The system 100 may receive event data 150 by accessing the Internet and searching for popular event. The system 100 may also receive event data 150 by accessing a company's internal intranet for current events. In another example, the system 100 may receive event data 150 from the company. For example, an employee of the company may identify events that are of interest to the company, such as adding a new gym, to determine if there may be any related sentiment change.

The trend analyzer 145 provides the review data 105 and 110 along with the identified topics, sentiments, and trends to the internal data analyzer 155. The internal data analyzer 155 analyzes internal data 160 that may only be accessible to an entity that is being reviewed. The internal data 160 may include demographic and employment data. For example, the internal data 160 may be human resources data that include for each employee, gender information, race information, employment dates, performance review information, income information, age, and tenure. The internal data 160 may also include previous reviews that employees have submitted. The internal data analyzer 155 may group the employees into particular groups. The internal data analyzer may determine whether each group has a common sentiment for a particular topic/aspect or exhibits a common sentiment trend. For example, the internal data analyzer 155 may identify a group of employees who have worked at the company for between two and three years. The internal data analyzer 155 may determine that that group of employees has an average sentiment score of 0.67, with a standard deviation of 0.10 for the topic/aspect of “work life balance.” The internal data analyzer 155 may identify a particular sentiment and corresponding topics/aspects and then determine data related to those employees who voiced that particular sentiment and topic/aspect. For example, the internal data analyzer 155 may identify a sentiment between 0 and 0.5 for the topic/aspect of “pay.” The internal data analyzer 155 may then determine the income, age, race, tenure, gender, and employment dates for the employees who left a review that related to “pay” and corresponded to a sentiment of 0 and 0.5. The internal data analyzer 155 may determine averages and standard deviations and other statistical computations for each piece of information for the group.

In some implementations, the internal data 160 may be stored in such a way to protect the identity of the employee. Employees may provide more frank reviews if the employees have confidence that they will not be reprimanded for providing negative reviews. However, it may still be helpful for the company to identify sentiments, topics, and trends for particular group of employees. The system 100 may associate a unique number for each employee and include that unique number for each of the employee's reviews. The internal data 160 may include that unique number and store it in association with each employee's company related data such as demographic, pay, and employment data. The internal data 160 may not include the employee's name. In some implementations, the internal data 160 may include the employee's name and be encrypted such that only the internal data analyzer 155 can decrypt the information. Data may be added to the internal data 160 to update an employee's profile in a one way encryption scheme.

The system provides the topics, sentiments, trends, and internal data to a graphical user interface generator that generates a user interface 165. The user interface includes graphical representations of sentiments and corresponding user groups. For example, the user interface 165 may include data illustrating a gender breakdown of sentiments greater than 0.0 for the topic/aspect “clients.” The user interface 165 may include options for the user to request data for a particular topic/aspect including a particular sentiment or sentiment range for a particular topic/aspect.

In some implementations, the system 100 includes access controls that allow the system 100 to filter and show information to users based on the each user's access level. The user may log into the system 100 to see the user interface 165. The system 100 identifies the user and filters information from the user interface 165 that the user is not authorized to see such as the sentiments for users of different pay levels.

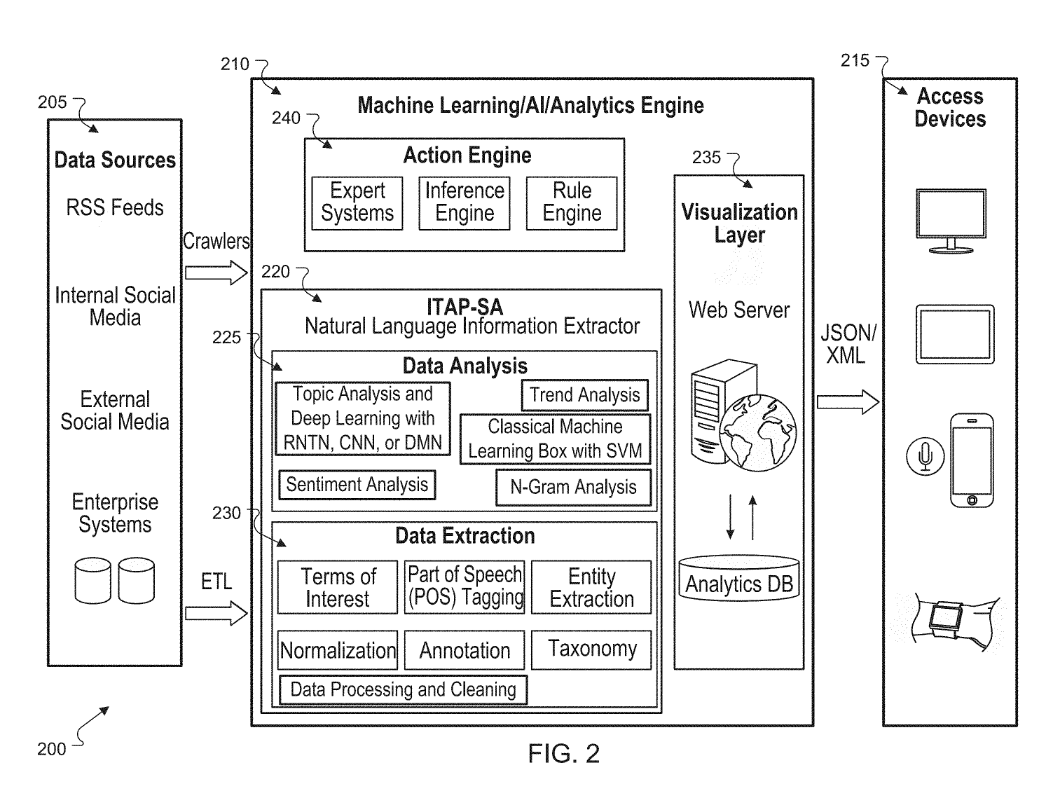

FIG. 2 illustrates an example system 200 that performs natural language processing of unstructured text. Briefly, and as described in further detail below, the system 200 receives review data from a variety of data sources 205. The system 200 provides the data from the data sources 205 to a cognitive computing engine 210. The cognitive computing engine 210 analyzes the data for display on access devices 215.

In the example shown in FIG. 2, the system receives data from data sources 205 that include RSS feeds, internal social media, external social media, and enterprise systems. The internal social media may be a social media platform that is only accessible by employees of a company. The employees may post information that is similar to that which the employees would post on an external social media platform. The internal social media platform may be moderated to keep the platform work related. The internal social media platform may also provide current event data related to the company that may not be public information. The RSS feeds may provide data related to current events such as news, politics, sports, and weather. The external social media may provide information from a company's social media page or presence. The enterprise systems may provide data that is internal to the company such as employment records that include employee demographics, employment history, pay, performance review information, or any combination of the four. These data sources provide mostly unstructured data. For example, the internal social media data may be text posts to the social media platform. The enterprise systems may provide structured data from a human resources database. In some implementations, the data sources may be attached to a particular rule or policy depending on who owns the data. For example, data retrieved from a website through RSS feeds may require handling a particular way, while data retrieved from a company's internal social network may not require special handing. The data sources may also include websites that are specifically designed to receive employee feedback that is related to their employer.

The system 205 provides the data from the data sources to the machine learning/AI/analytics engine 210. The machine learning/AI/analytics engine 210 analyzes the data from the data sources 205 using machine learning and natural language processing to identify topics/aspects and corresponding sentiments. The machine learning/AI/analytics engine 210 may also identify trends and correlate the topics/aspects and sentiments to groups of employees and generate user interfaces based on the topics, sentiments, and groups.

The machine learning/AI/analytics engine 210 includes a natural language information extractor 220 that processes the data received from the data sources 205 based on natural processing techniques. The natural language information extractor 220 includes a data extraction engine 230. The data extraction engine 230 is configured to process unstructured data such as text reviews that employees provide to review websites or directly to their employers. The unstructured data may include some structure such as a timestamp, location of device where the employee entered the information, and an identifier for the employee, but mostly the unstructured data is a text string. The data extraction engine 230 identifies terms of interest in the unstructured data. The terms of interest may be terms that the employer is particularly interested in such as “pay,” “management,” or “balance.” The terms of interest may be based on a taxonomy that an employer provided to the system 200 and that is similar to the taxonomy data described above. The data extraction engine 230 may identify parts of speech of the unstructured data.

In some implementations, the machine learning/AI/analytics engine 210 receives data that may be associated with more than one entity. For example, the machine learning/AI/analytics engine 210 receives a review of Acme Company from employee who is a user of an external social media platform and a review of XYZ Corporation from another employee who also uses the external social media platform. The data extraction engine 230 identifies that one review is for Acme and the other review is for XYZ and processes each according to the instructions provided by the respective entity. The data extraction engine 230 may also annotate the unstructured data. For example, the data extraction engine 230 may annotate a review to indicate any special handling such as a rule that may be specified by the data owner or the company being reviewed. The data extraction engine 230 may normalize the unstructured data. For example, the data extraction engine 230 may break up a longer review into small reviews to more closely match the average review size.

The natural language processing engine also includes a data analysis engine 225. The data analysis engine 225 parses, classifies, and identifies sentiments for the unstructured data. The data analysis engine 225 classifies each data entry as being related to one or more topics/aspects. The data analysis engine 225 may identify keywords that are part of a taxonomy as described above. The data analysis engine 225 may use a linear support vector machine. The data analysis engine 225 may also use n-gram analysis to identify patterns in particular term usage. The data analysis engine 225 may extract sentiments from the data entries using recursive neural tensor networks or other deep learning algorithms. The data analysis engine 225 may identify trends in sentiments for different topics/aspects. The data analysis engine 225 may also identify trends in term usage using n-gram analysis and, if necessary, flag terms for further processing. For example, the data analysis engine 225 may identify one or more words that appear with increased frequency in reviews. The data analysis engine 225 may provide instructions to the visualization layer 235 to incorporate a visualization for the increasingly common terms.

The machine learning/AI/analytics engine 210 includes an action engine 240 that includes a rule engine, an inference engine, and expert systems. The rule engine may provide rules for handling particular types of data. For example, data received from an internal company's network may have different handling rules than data received from an external social networking platform. The inference engine may be configured to infer that particular trends may be related to other trends or outside or internal events. For example, the inference engine may infer that an increase in pay event may be correlated to an increase in sentiment regarding a “work life balance” topic/aspect instead of only correlating the event to an increase in sentiment regarding “pay” topic/aspect. The expert systems may be configured to emulate a decision of a human expert and may include various rules that are programmed into the system 200. For example, the expert system may execute optimization rules to improve the accuracy of the classification process that identifies topics/aspects for each review.

The machine learning/AI/analytics engine 210 includes a visualization layer 235 that is configured to generate user interfaces that illustrate the trends and sentiments as they relate to the group of employees who provided the reviews. The visualization layer 235 may provide the user interface to a web server for access by the access devices 215. The access devices 215 may include desktop computers, laptop computers, mobile devices, wearable devices, tablets, or any other similar device. The may access the user interfaces through the Internet or through an internal company network.

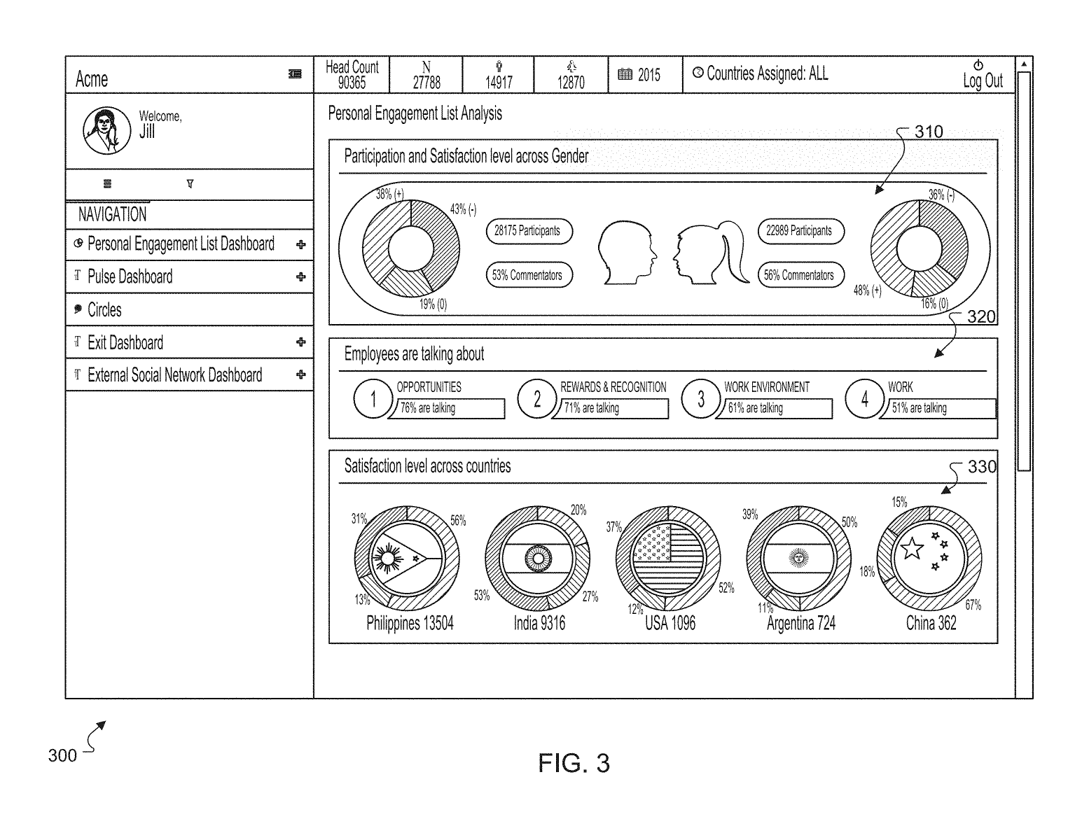

FIG. 3 illustrates an example user interface 300 for a system that performs natural language processing of unstructured text. The user interface 300 includes a general overview of employee sentiment for particular user groups. The user interface 30 includes the employees grouped by gender and country location. Section 310 illustrates the general satisfaction for each gender at Acme Corporation. The pie charts on either side of section 310 break down the sentiments into three groups. For the male pie chart, there were 28,175 participants who submitted reviews, which represents 53% of the male employees. Of those who submitted reviews, 38% included a positive sentiment, 19% included a neutral sentiment, and 43% included a negative sentiment. For the female side, 22,989 employees of Acme submitted reviews, which represents 36% of the female employees. Of those submitted reviews, 48% included a positive sentiment, 16% included a neutral sentiment, and 36% included a negative sentiment.

Section 320 includes the popular identified topics/aspects based on analysis of the employee reviews for Acme. The most popular topic/aspect was opportunities, which was included in 76% of the reviews. The other topics/aspects included rewards and recognition, work environment, and work, which were included in 71%, 61%, and 51% of the reviews respectively. Section 330 illustrates satisfaction for each employment location. For example, in the USA, 1,096 employees submitted reviews. Of the USA reviews, 52% were positive, 12% were neutral, and 37% were negative. In another example, in China, 362 employees submitted reviews. Of the Chinese reviews, 67% were positive, 18% were neutral, and 15% were negative. Similar shading patterns for other countries correspond to positive, neutral, and negative sentiment portions.

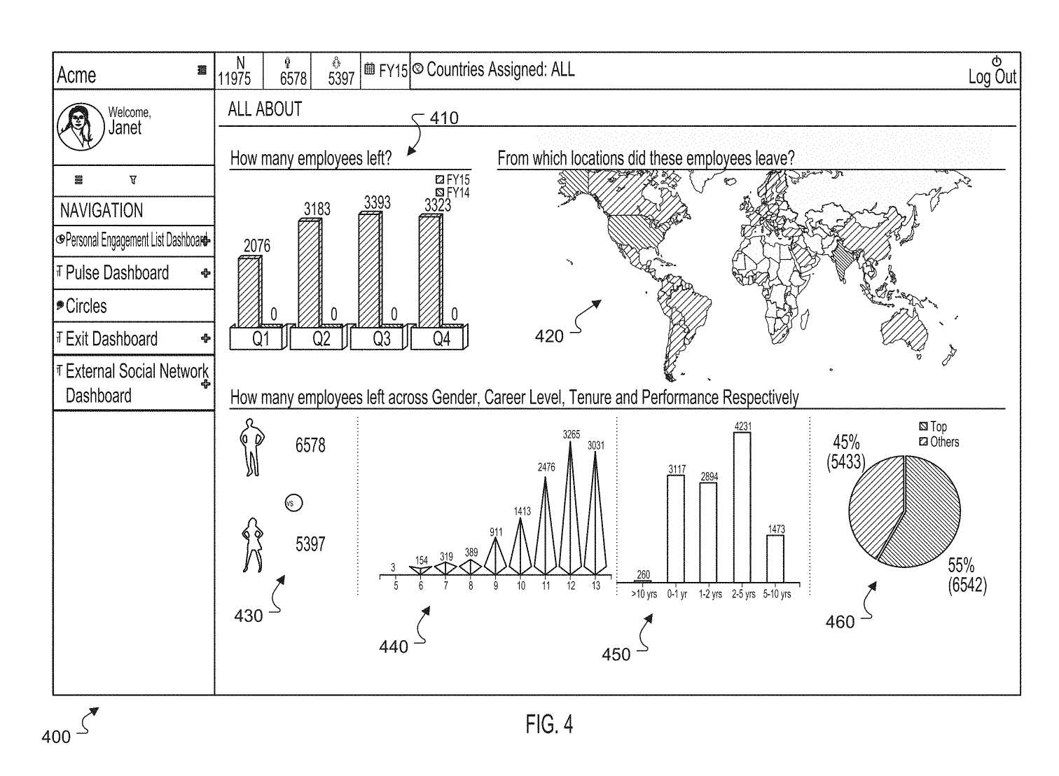

FIG. 4 illustrates example user interface 400 for structured and unstructured data processing. Because tracking employee satisfaction is critical to employee retention, the system is configured to present data related to employee retention. The user may be able to identify groups of employees who left earlier than would be expected and identify particular topics/aspects that were associated with negative sentiments. In user interface 400, section 410 illustrates a number of employees that left each quarter for the current year and the previous year. The current year data may not be available until the system has processed the data, but the previous year indicates that employee separation was fairly consistent for quarters two through four. The first quarter shows lower employee separation rates. Section 420 illustrates the countries where employees left from. The tighter the cross-hatching, the higher the separation rate for the employees. Based on section 420, India had the highest separation rate.

Sections 430, 440, 450, and 460 illustrate separation statistics for different groups of employees. The data illustrated in these sections may be for similar time periods as section 410 or may be for time periods selected by the user. Section 430 indicates that 6,578 males left and 5,397 females left. Section 440 indicates that employees at higher career levels left. Section 450 illustrates that the largest tenured group to leave Acme had worked there for two to five years. Section 460 illustrates that of the employees who left, 55% were top performers and 45% were in the remaining performance group.

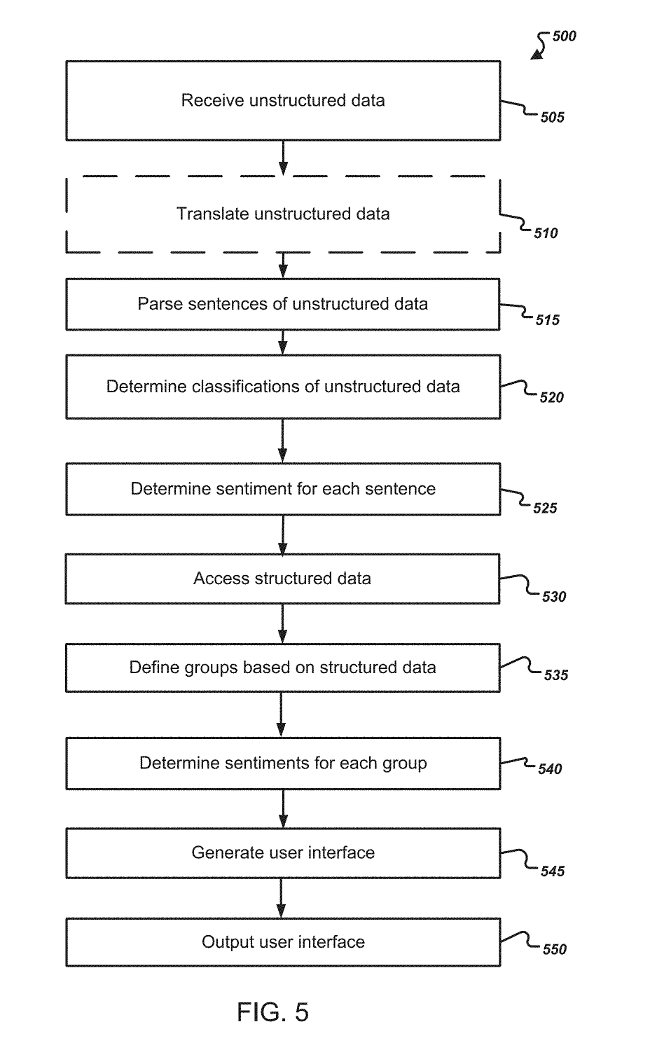

FIG. 5 illustrates an example process 500 for performing natural language processing of unstructured text. In general, the process 500 processes unstructured data, such as employee reviews, determines topics/aspects and sentiments of the employees' reviews, and combines them with structured data to provide a user with information related to employee satisfaction for different employee groups. The process 500 will be described as being performed by a computer system comprising one or more computers, for example, the systems 100 or 200 as shown in FIG. 1 or 2.

The system receives unstructured data (505). In some implementations, the unstructured data is text data that is received from employees who are providing reviews for their employer. The system determines a language of the unstructured data and, if necessary, translates the unstructured data to a common language, such as English (510). Because many companies operate throughout the world, the system is configured to identify a language in which the employee provided the review. The system parses the sentences of the unstructured data (515). The system identifies subjects, objects, and verbs for the sentences.

The system determines classifications of unstructured data (520). In some implementations, the classifications are provided the employer who is being reviewed. For example, an employer may want to receive data related to employee thoughts on pay, work life balance, and career growth opportunities. In this instance, the employer may provide the system with a list of classifications or topics/aspects to identify in the reviews. In some implementations, the system identifies keywords that are part of a larger taxonomy. Each classification may be associated with various sub-classification and even more keywords. Some classifications may have excluded keywords.

The system determines a sentiment for each sentence (525). In some implementations, the system determines sentiments using a recursive neural tensor network, a linear support vector machine, a convolutional neural network, a dynamic memory network, or a rule based algorithm. These techniques may also be used for identifying themes or classifications. The sentiments may reflect how an employee feels about a particular topic/aspect. The system may identify sentiments by identifying particular keywords that may related to the keywords related to the classifications. The system may use the parsed sentence to associate sentiment keyword with classification keywords so that each sentiment may be properly matched to a classification. In some implementations, the system determines a sentiment for each classification, or topic/aspect. For example, a review may include multiple sentences that relate to “work life balance.” The system may then determine a sentiment and sentiment intensity score for the multiple sentences.

The system accesses structured data (530). In some implementations, the structured data is demographic data, employment data, and location data. The structured data may be human resources data that the employer has complied from employment records. The system defines groups based on the structured data (535). For example, the system may group employees by gender, tenure, or duty location. The system may also group employees title, department, or pay level.

The system determines sentiments for each group (540). In some implementations, the system accesses data that is related to the employer. For example, the system may access data related to events within the company such as a CEO change or a merger. The system may correlate those events with sentiments using any timestamps that were included with the employee reviews. In some implementations, the system may use the timestamps to identify sentiment trends. For example, the system may determine that sentiment for the “work like balance” classification has been increasing over the past year. In some implementations, the system may receive reviews for more than one employer. The system may receive additional structured data for different employers and create different groups of employees that may work for the different employer. The system may then relate those groups to sentiments and classifications. The system generates a user interface based on the groups, sentiments, and classifications (545). The system outputs the user interface (550). In some implementations, the system may retrieve sample text snippets that are filtered according to intensity scores, for user analysis to identify positive and negative sentiments.

In some implementations, the system may utilize the sentiments for each group to predict a sentiment for a new employee. For example, the system may identify that users who have ten to fifteen years of previous experience, are male, have a master's degree, and work in the accounting division have a sentiment of −0.6 with respect to “work life balance” and a sentiment of −0.5 with respect to “pay.” In this instance, if the employer was considering hiring an employee who fit those classifications, then it is likely that the employee will have similar sentiments. The employer may wish to identify a group of employees with higher sentiments and tailor a search for a new employee to fit the profile of the group of employees with higher sentiments.

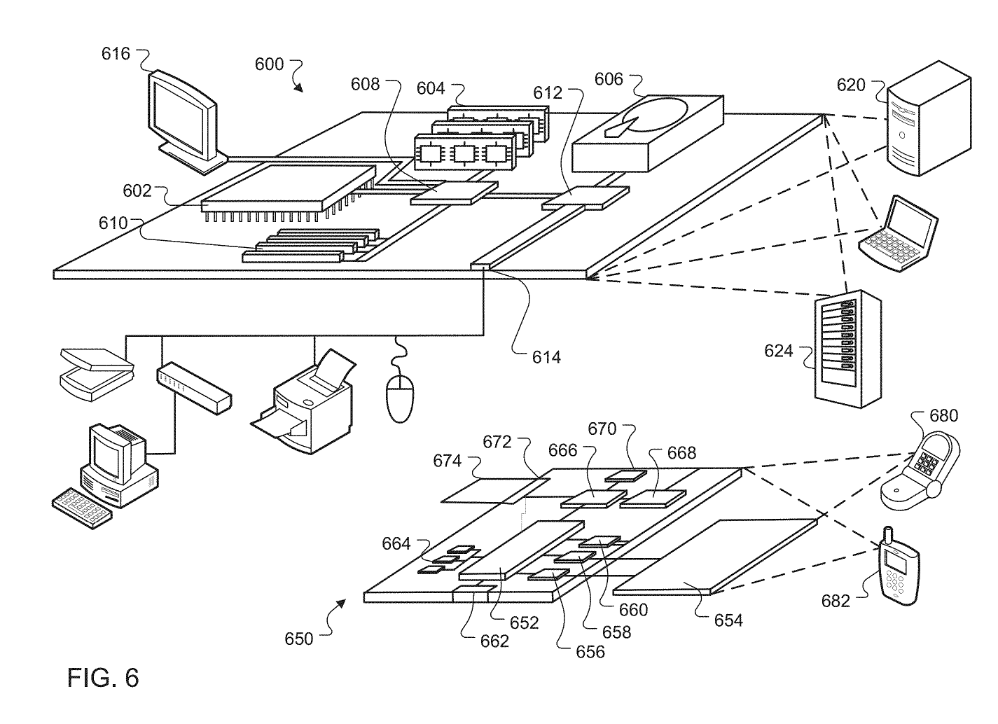

FIG. 6 shows an example of a computing device 600 and a mobile computing device 650 that can be used to implement the techniques described here. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine-readable mediums (for example, the memory 604, the storage device 606, or memory on the processor 602).

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 652), perform one or more methods, such as those described above. The instructions can also be stored by one or more storage devices, such as one or more computer- or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver. In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method comprising:
receiving one or more unstructured data entries that each include one or more sentences, are each associated with an entity, and are each from a user;
for each unstructured data entry, determining whether to translate the one or more sentences in the unstructured data entry to a common language;
for each unstructured data entry, parsing the one or more sentences;
based on the parsed one or more sentences, determining one or more classifications of each unstructured data entry;
for each of the one or more classifications, determining a sentiment;
accessing structured data that is associated with each entity;
defining one or more groups of users based on the structured data, wherein each of the one or more groups shares a common characteristic in the structured data;
for each of the one or more groups of users, determining sentiments to associate with the group based on the sentiments associated with the one or more unstructured data entries and based on the entity associated with the respective unstructured data entries;
generating a user interface that includes interface elements for each of the one or more groups and the associated sentiments and classifications; and
providing, for output, the user interface.

2. The method of claim 1, wherein determining a sentiment comprises:
determining the sentiment using one or more of a recursive neural tensor network, a linear support vector machine, a convolutional neural network, a dynamic memory network, or a rule based algorithm.

3. The method of claim 1, comprising:
receiving additional structured data that is associated with an additional user;
based on the additional structured data, identifying, from the one or more groups, a particular group to associate with the additional user; and
determining that the additional user will be associated with the sentiment that is associated with the particular group.

4. The method of claim 1, wherein the structured data comprises demographic data, employment data, and location data.

5. The method of claim 1, wherein:
each of the one or more unstructured data entry includes a time stamp, and
determining sentiments to associate with the group comprises determining sentiment trends to associate with the group.

6. The method of claim 5, comprising:
identifying one or more events that are associated with a respective entity of the structured data; and
determining a relationship between the sentiment trends and the one or more events.

7. The method of claim 1, comprising:
receiving, from an owner of the structured data or from a respective entity, data identifying the one or more classifications.

8. The method of claim 1, comprising:
for each of the one or more classifications, determining a sentiment intensity score,
wherein determining sentiments to associate with the group comprises determining a sentiment intensity score to associate with the group based on the sentiment intensity scores.

9. A system comprising:
one or more computers and one or more storage devices storing instructions that are operable, when executed by the one or more computers, to cause the one or more computers to perform operations comprising:
receiving one or more unstructured data entries that each include one or more sentences, are each associated with an entity, and are each from a user;
for each unstructured data entry, determining whether to translate the one or more sentences in the unstructured data entry to a common language;
for each unstructured data entry, parsing the one or more sentences;
based on the parsed one or more sentences, determining one or more classifications of each unstructured data entry;
for each of the one or more classifications, determining a sentiment;
accessing structured data that is associated with each entity;
defining one or more groups of users based on the structured data, wherein each of the one or more groups shares a common characteristic in the structured data;
for each of the one or more groups of users, determining sentiments to associate with the group based on the sentiments associated with the one or more unstructured data entries and based on the entity associated with the respective unstructured data entries;
generating a user interface that includes interface elements for each of the one or more groups and the associated sentiments and classifications; and
providing, for output, the user interface.

10. The system of claim 9, wherein determining a sentiment comprises:
determining the sentiment using one or more of a recursive neural tensor network, a linear support vector machine, a convolutional neural network, a dynamic memory network, or a rule based algorithm.

11. The system of claim 9, wherein the operations further comprise:
receiving additional structured data that is associated with an additional user;
based on the additional structured data, identifying, from the one or more groups, a particular group to associate with the additional user; and
determining that the additional user will be associated with the sentiment that is associated with the particular group.

12. The system of claim 9, wherein the structured data comprises demographic data, employment data, and location data.

13. The system of claim 9, wherein:
each of the one or more unstructured data entry includes a time stamp, and
determining sentiments to associate with the group comprises determining sentiment trends to associate with the group.

14. The system of claim 13, wherein the operations further comprise:
identifying one or more events that are associated with a respective entity of the structured data; and
determining a relationship between the sentiment trends and the one or more events.

15. The system of claim 9, wherein the operations further comprise:
receiving, from an owner of the structured data or from a respective entity, data identifying the one or more classifications.

16. The system of claim 9, wherein the operations further comprise:
for each of the one or more classifications, determining a sentiment intensity score,
wherein determining sentiments to associate with the group comprises determining a sentiment intensity score to associate with the group based on the sentiment intensity scores.

17. A non-transitory computer-readable medium storing software comprising instructions executable by one or more computers which, upon such execution, cause the one or more computers to perform operations comprising:
receiving one or more unstructured data entries that each include one or more sentences, are each associated with an entity, and are each from a user;
for each unstructured data entry, determining whether to translate the one or more sentences in the unstructured data entry to a common language;
for each unstructured data entry, parsing the one or more sentences;
based on the parsed one or more sentences, determining one or more classifications of each unstructured data entry;
for each of the one or more classifications, determining a sentiment;
accessing structured data that is associated with each entity;
defining one or more groups of users based on the structured data, wherein each of the one or more groups shares a common characteristic in the structured data;
for each of the one or more groups of users, determining sentiments to associate with the group based on the sentiments associated with the one or more unstructured data entries and based on the entity associated with the respective unstructured data entries;
generating a user interface that includes interface elements for each of the one or more groups and the associated sentiments and classifications; and
providing, for output, the user interface.

18. The medium of claim 17, wherein determining a sentiment comprises:
determining the sentiment using one or more of a recursive neural tensor network, a linear support vector machine, a convolutional neural network, a dynamic memory network, or a rule based algorithm.

19. The medium of claim 17, wherein the operations further comprise:
receiving additional structured data that is associated with an additional user;
based on the additional structured data, identifying, from the one or more groups, a particular group to associate with the additional user; and
determining that the additional user will be associated with the sentiment that is associated with the particular group.

20. The medium of claim 17, wherein:
each of the one or more unstructured data entry includes a time stamp, and
determining sentiments to associate with the group comprises determining sentiment trends to associate with the group.
